(19) United States
(12) Patent Application Publication
(10) Pub. No.: US 2024/0069913 A1
(43) Pub. Date: Feb. 29, 2024

(54) Uniform Microcode Update Enumeration

(71) Applicant: Intel Corporation, Santa Clara, CA (US)

(72) Inventors: Avinash Chandrasekaran, Mountain View, CA (US); Hisham Shafi, Folsom, CA (US); Jeffrey G. Wiedemeier, Austin, TX (US)

(21) Appl. No.: 17/898,436

(22) Filed: Aug. 29, 2022

(51) Int. Cl. G06F 9/22; G06F 9/445

(52) U.S. Cl. CPC G06F 9/226; G06F 9/44505

(57) ABSTRACT

Systems, methods, and devices are provided for identification of model-specific behavior relating to microcode update capabilities of a processor to enable efficient microcode updates across a range of different machines. A system may include a first processor core and a second processor core. A register of the system may indicate a hardware capability of the system to perform a uniform microcode update by propagating a microcode update from the first processor core to a second processor core.

### BACKGROUND

This disclosure relates to identification of model-specific behavior relating to microcode update capabilities of a processor to enable efficient microcode updates across a range of different machines.

A vast array of electronic devices—such as computers, internet datacenters, handheld phones and gaming devices, wearables, automobiles, and industrial robotics—include processors to implement a variety of data processing. The behavior of a processor is determined by microcode that runs deep within the processor. After a processor has been released, the microcode may be updated to provide additional functionality to the processor or to correct errata. Many processors have multiple processor cores in a single package or may be collocated with other processors in a platform. Microcode may be stored and run individually by each logical processor core of a processor. As such, one way to perform a microcode update on an entire platform is to initiate a microcode update on each logical processor. This may be time consuming, particularly as the number of processor cores in a processor package and the number of processor packages in a platform continue to increase dramatically.

### BRIEF DESCRIPTION OF THE DRAWINGS

Various aspects of this disclosure may be better understood upon reading the following detailed description and upon reference to the drawings in which:

FIG. 1 illustrates a block diagram of a system for performing a microcode update with a platform scope, in accordance with an embodiment;

FIG. 2 illustrates a block diagram of a system for performing a microcode update with a package scope, in accordance with an embodiment;

FIG. 3 illustrates a block diagram of a system for performing a microcode update with a processor core scope, in accordance with an embodiment;

FIG. 4 illustrates an example computing system that may be used to perform a microcode update, in accordance with an embodiment;

FIG. 5 illustrates a block diagram of an example processor and/or System on a Chip (SoC) that may have one or more cores and an integrated memory controller, in accordance with an embodiment;

FIG. 6 is a block diagram illustrating both an example in-order pipeline and an example register renaming, out-of-order issue/execution pipeline, in accordance with an embodiment;

FIG. 7 is a block diagram illustrating both an example in-order architecture core and an example register renaming, out-of-order issue/execution architecture core to be included in a processor, in accordance with an embodiment;

FIG. 8 illustrates examples of execution unit(s) circuitry, in accordance with an embodiment;

FIG. 9 is a block diagram of a register architecture, in accordance with an embodiment;

FIG. 10 is a block diagram of register architecture of model-specific registers (MSRs) used to enumerate microcode update capabilities of a computer system, in accordance with an embodiment; and

FIG. 11 is a flowchart of a method for performing a microcode update based on the MSRs of FIG. 10, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B. Moreover, this disclosure describes various data structures, such as instructions for an instruction set architecture. These are described as having certain domains (e.g., fields) and corresponding numbers of bits. However, it should be understood that these domains and sizes in bits are meant as examples and are not intended to be exclusive. Indeed, the data structures (e.g., instructions) of this disclosure may take any suitable form.

This disclosure describes systems and methods to efficiently perform microcode updates across a range of different versions of processors with different microcode update capabilities. Indeed, while each logical processor core of a processor package may have its own microcode that is updated in a microcode update, some recent versions of processors may include a mechanism by which initiating a microcode update on one logical processor core of a processor package causes the microcode update to propagate to the other logical processor cores of other processors in the package. Other recent versions of processors may be capable of propagating a microcode update to other processor packages within the same platform. These capabilities may significantly increase the ease and efficiency of performing a microcode update, particularly as the processor core count of many new processor products continues to grow.

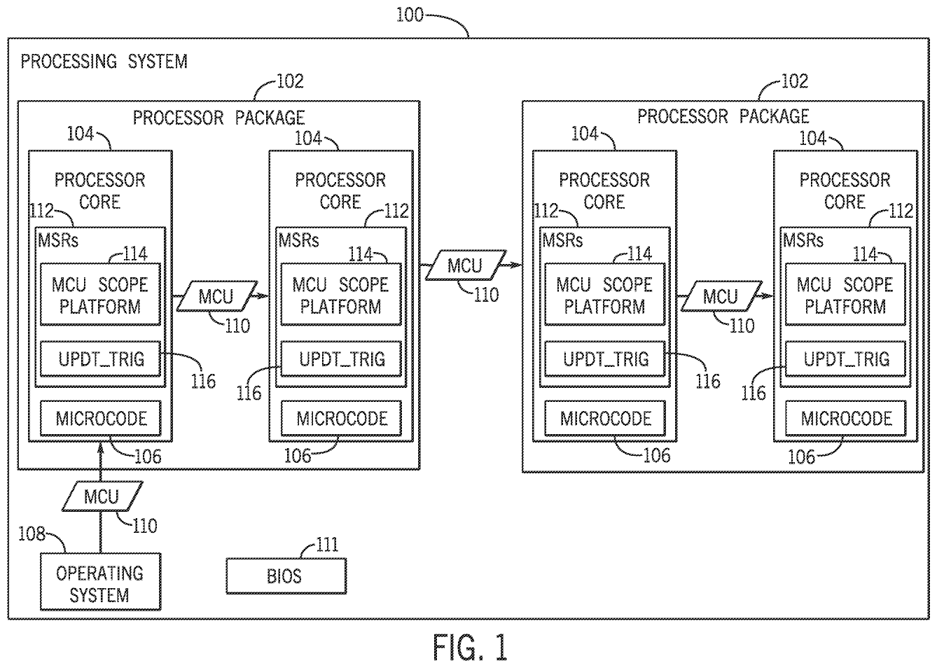

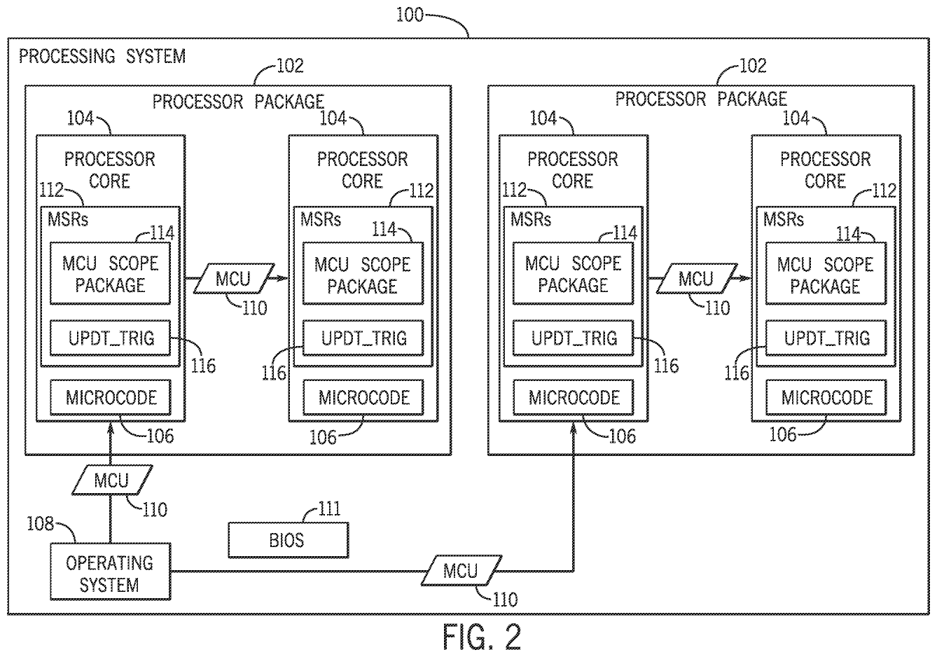

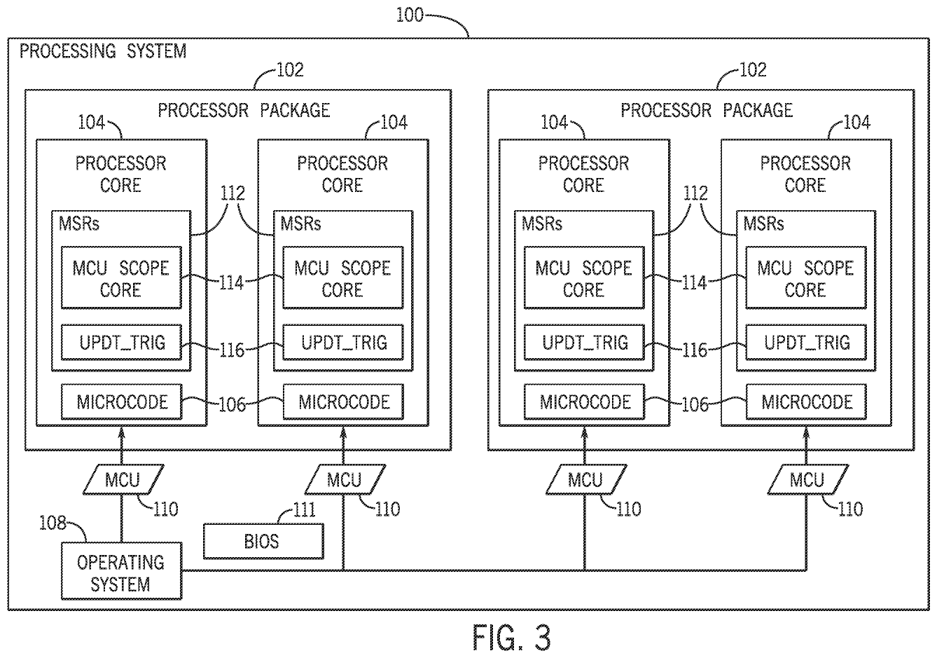

FIGS. 1, 2, and 3 illustrate three different ways that microcode updates may be performed on processing systems 100 that have different microcode update capabilities. Indeed, as shown in FIGS. 1 and 2, certain hardware may have a capability that enables a uniform microcode update, in which a microcode update that is initiated on one processor core may propagate to other cores in a package (package scope) or to other cores in other packages on the same platform (platform scope). FIG. 1 illustrates an example of a microcode update with a platform scope, FIG. 2 illustrates an example of a microcode update with a package scope, and FIG. 3 illustrates an example of a microcode update with a processor core scope. In FIGS. 1, 2 and 3, a processing system 100 is shown that includes multiple processor packages 102. Each processor package 102 may include one or more processor cores 104, which operate based on microcode 106 stored in read-only memory of the processor core 104. There may be any suitable number of processor cores 104 per processor package 102, and there may be any suitable number of processor packages 102 in the processing system 100.

The microcode 106 provides a layer of computer organization between the processor core 104 hardware and the programmer-visible instruction set architecture (ISA) of the processing system 100. The underlying hardware of the processor cores 104 may not be directly exposed. The microcode 106, in coordination with the hardware of the processor cores 104, implements the programmer-visible ISA. In this way, the underlying hardware of the processor cores 104 may not have a fixed relationship to the instruction set architecture used by programmers. Updates to the microcode 106 may provide the processor core 104 with additional functionality or may correct errata of the hardware of the processor core 104 or a previous version of the microcode 106. An operating system 108 running on the processing system 100 may perform a microcode update 110 on the processor cores 104. The operating system 108 may represent any suitable software with a lowest-level of access to the processing system 100. In some cases, the microcode update 110 shown to be performed by the operating system 108 may be performed by a basic input-output system (BIOS) 111 of the processing system 100.

Microcode updates are done on a per-core basis. Some processing systems 100 may have additional hardware capabilities by which the microcode update (MCU) 110 may be propagated to other processing cores 104 in a processor package 102 (package-scoped microcode updates) or even to other processor cores 104 of a different processor package 102 (platform-scoped microcode updates). Since it would be inefficient to perform per-core microcode updates if the processing system 100 has the capability to perform package-scoped or platform-scoped microcode updates and could potentially result in errors if a platform- or package-scoped update were attempted on a processing system 100 without such capabilities the operating system 108 may access certain model-specific registers (MSRs) 112 to determine the microcode update capabilities of the processing system 100. There may be numerous MSRs 112 on each processor core 104. At least one MSR 112 may represent an MCU scope register 114 that indicates the microcode update capabilities of the processing system 100 (e.g., per-core only, package scope, platform scope). An update trigger register 116 (e.g., IA32_BIOS_UPDT_TRIG) may be used to trigger the microcode update when the operating system 108 executes a write MSR (e.g., WRMSR) instruction to the Update Trigger register 116 (e.g., WRMSR 79). There may be additional MSRs 112, discussed further below, that may further assist the operating system 108 or BIOS 111 with the microcode update capabilities of the processing system 100.

As mentioned above, different versions of the processing system 100 may have different microcode update capabilities. In the example of FIG. 1, as indicated by the MCU scope register 114, the microcode update scope for the processing system 100 is per platform. Thus, the operating system 108 may simply perform a microcode update (MCU) 110 on one of the processor cores 104 of one of the processor packages 102, and the MCU 110 may be propagated to all other processing cores 104 of the processing system 100. In the example of FIG. 2, as indicated by the MCU scope register 114, the microcode update scope for the processing system 100 is per-package. Thus, the operating system 108 may perform separate microcode updates (MCUs) 110 on one of the processor cores 104 of each of the processor packages 102. From the first processor core 104 of each processor package 102, the MCU 110 may be propagated to all other processor cores 104 of that processor package 102. In the example of FIG. 3, as indicated by the MCU scope register 114, the microcode update scope of the processing system 100 is per core. Thus, the operating system 108 may perform separate microcode updates (MCUs) 110 on all of the processor cores 104 of each of the processor packages 102. In this way, the operating system 108 may perform microcode updates in a highly efficient manner as supported by the processing system 100, without introducing potential problems posed by hardware that is not designed for higher-efficiency microcode updates.

### Example Computer Architectures

The processing system 100 may represent any suitable computer system. Several examples will be discussed further below. Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

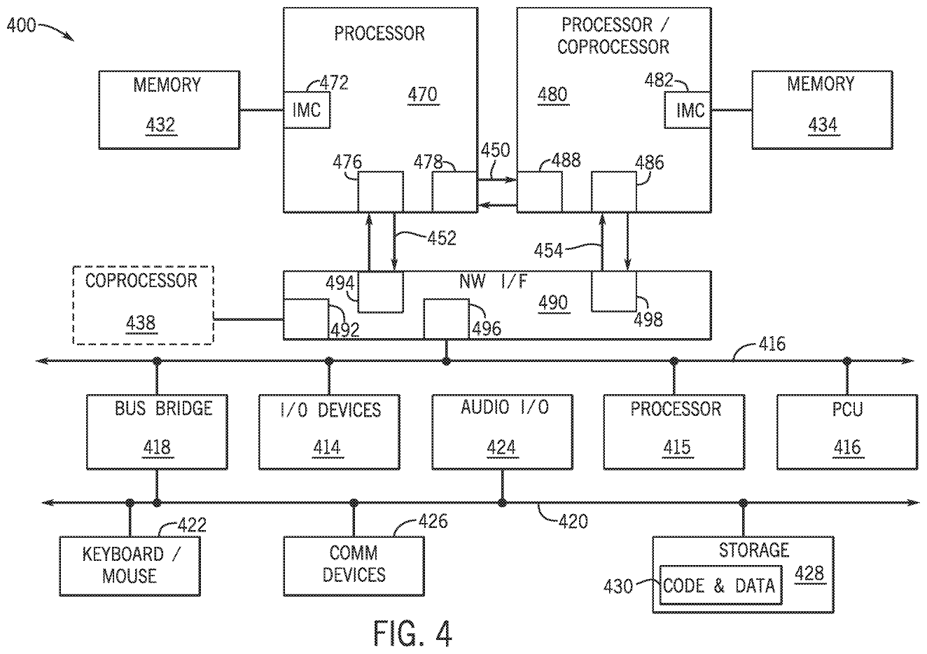

FIG. 4 illustrates an example computing system that may represent the processing system 100. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 426 and storage circuitry 428. Storage circuitry 428 may be one or more non-transitory machine-readable storage media as described below, such as a disk drive or other mass storage device which may include instructions/code and data 430 and may implement storage for executing instructions in some examples. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

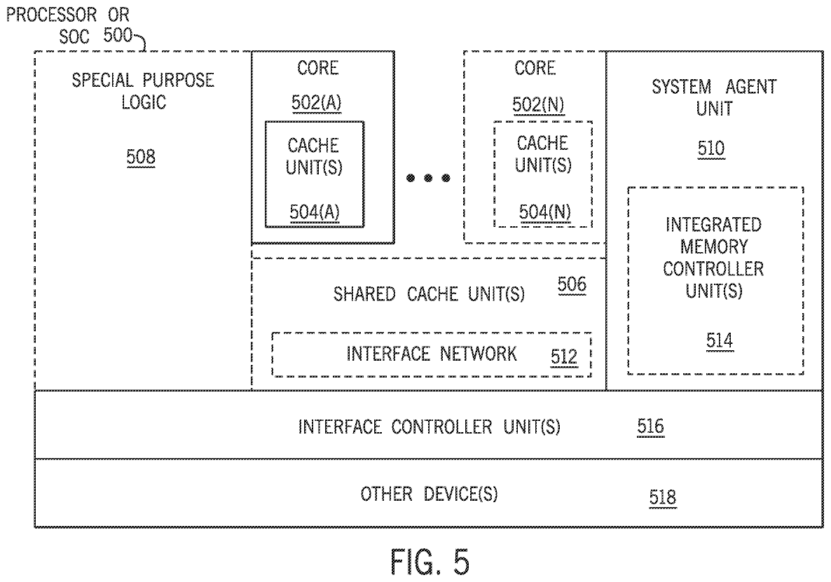

FIG. 5 illustrates a block diagram of an example processor and/or SoC 500 that may have one or more processor cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 460 or 490, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller units circuitry 516 couple the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures—In-Order and Out-of-Order Core Block Diagram

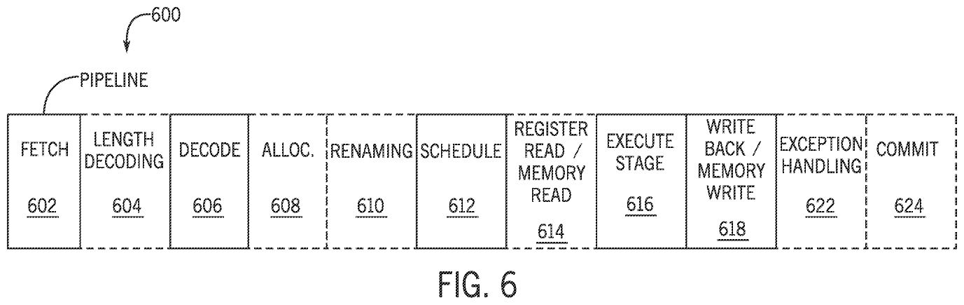

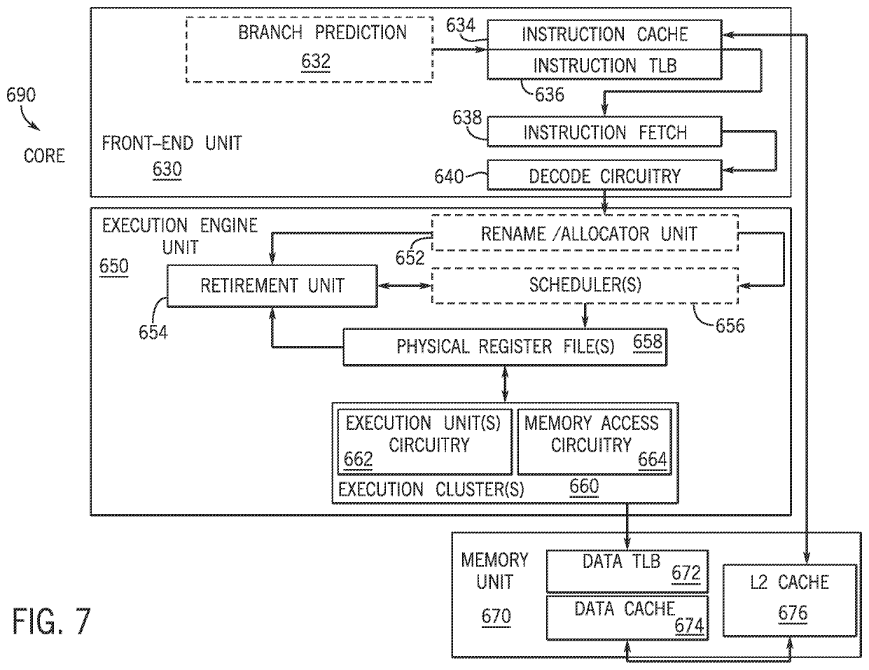

FIG. 6 is a block diagram illustrating both an example in-order pipeline and an example register renaming, out-of-order issue/execution pipeline according to examples. FIG. 7 is a block diagram illustrating both an example in-order architecture core and an example register renaming, out-of-order issue/execution architecture core to be included in a processor according to examples. The solid lined boxes in FIGS. 6 and 7 illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6, a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7 may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 7 shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry

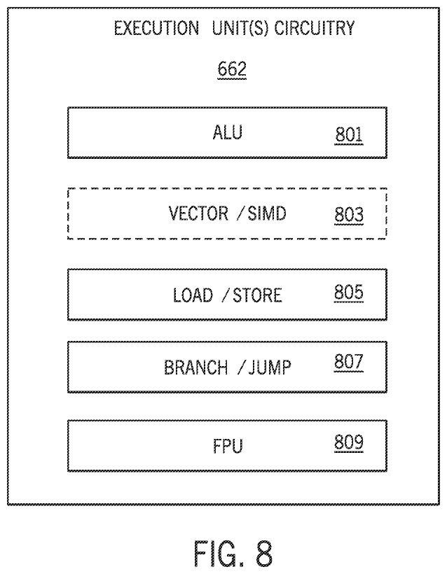

FIG. 8 illustrates examples of execution unit(s) circuitry, such as execution unit(s) circuitry 662 of FIG. 7. As illustrated, execution unit(s) circuitry 662 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

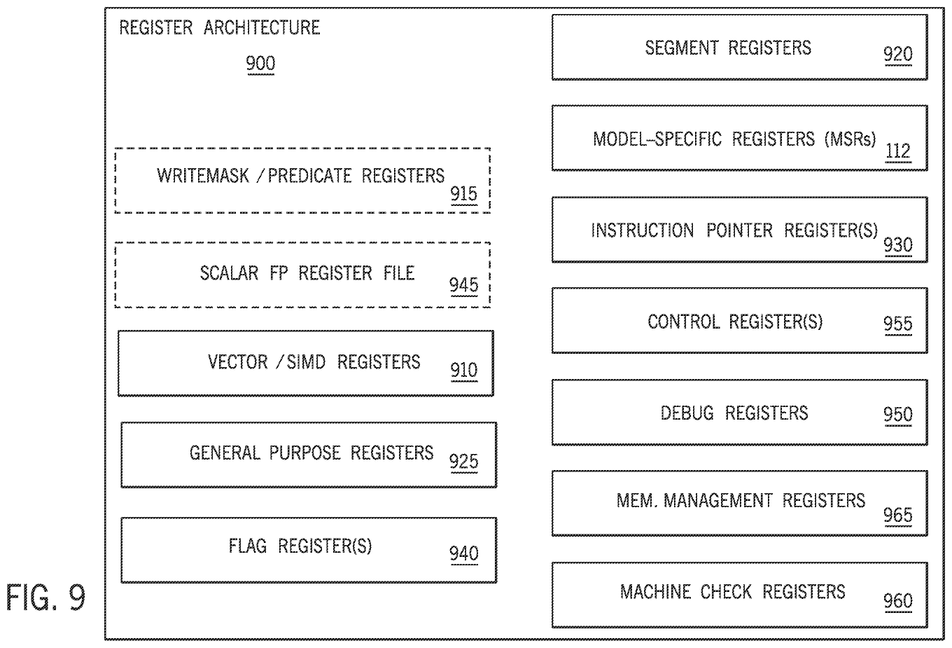

FIG. 9 is a block diagram of a register architecture 900 according to some examples. As illustrated, the register architecture 900 includes vector/SIMD registers 910 that vary from 128-bit to 1,024 bits width. In some examples, the vector/SIMD registers 910 are physically 512-bits and, depending upon the mapping, only some of the lower bits are used. For example, in some examples, the vector/SIMD registers 910 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 900 includes writemask/predicate registers 915. For example, in some examples, there are 8 writemask/predicate registers (sometimes called k0 through k7) that are each 16-bit, 32-bit, 64-bit, or 128-bit in size. Writemask/predicate registers 915 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 915 corresponds to a data element position of the destination. In other examples, the writemask/predicate registers 915 are scalable and consists of a set number of enable bits for a given vector element (e.g., 8 enable bits per 64-bit vector element).

The register architecture 900 includes a plurality of general-purpose registers 925. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 900 includes scalar floating-point (FP) register file 945 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 940 (e.g., EFLAGS, RFLAGS, etc.) store status and control information for arithmetic, compare, and system operations. For example, the one or more flag registers 940 may store condition code information such as carry, parity, auxiliary carry, zero, sign, and overflow. In some examples, the one or more flag registers 940 are called program status and control registers.

Segment registers 920 contain segment points for use in accessing memory. In some examples, these registers are referenced by the names CS, DS, SS, ES, FS, and GS.

Model-specific registers (MSRs) 112, sometimes referred to as machine specific registers, control and report on processor performance. Most MSRs 112 handle system-related functions and are not accessible to an user-application program. Machine check registers 960 include (e.g., in some cases, consist of, control, status, and error reporting MSRs) that are used to detect and report on hardware errors.

One or more instruction pointer register(s) 930 store an instruction pointer value. Control register(s) 955 (e.g., CR0-CR4) determine the operating mode of a processor (e.g., processor 460, 490, 438, 415, and/or 500) and the characteristics of a currently executing task. Debug registers 950 control and allow for the monitoring of a processor or core's debugging operations.

Memory (mem) management registers 965 specify the locations of data structures used in protected mode memory management. These registers may include a global descriptor table register (GDTR), interrupt descriptor table register (IDTR), task register, and a local descriptor table register (LDTR) register. The memory management registers 965 may include processor reserved memory range registers (PRMRR), which may represent any one or more storage locations in memory or storage units or elsewhere in processor. The PRMRR may be used, for example, by configuration firmware such as a basic input/output system (BIOS), to reserve one or more physically contiguous ranges of memory called processor reserved memory (PRM). For certain versions of the processing system 100, the configuration of the PRMRR is done before a microcode update may occur.

Alternative examples may use wider or narrower registers. Additionally, alternative examples may use more, less, or different register files and registers. The register architecture 900 may, for example, be used in register file/memory, or physical register file(s) circuitry 658.

### Microcode Update Enumeration in Model-Specific Registers

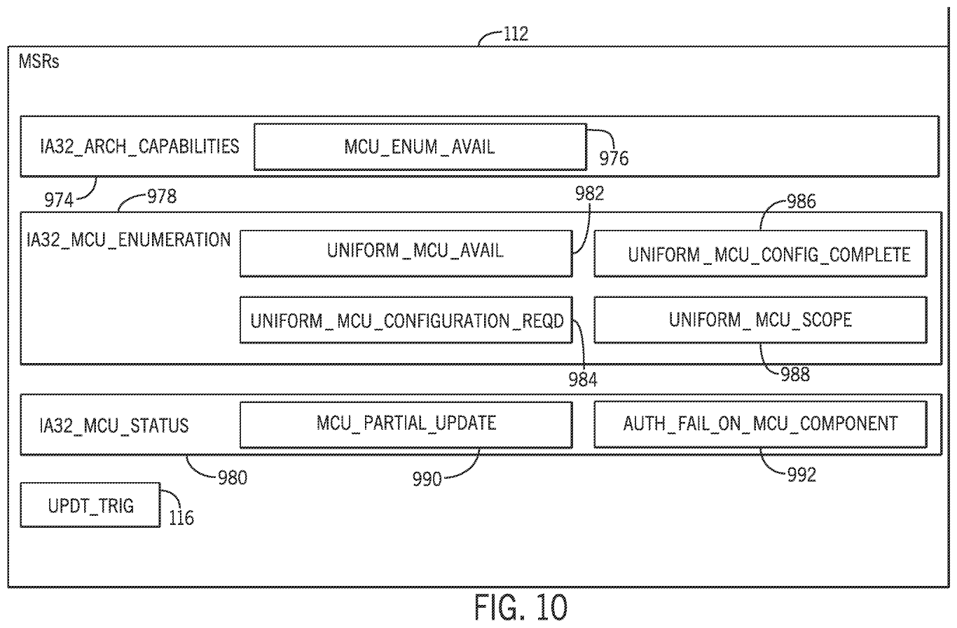

Software such as an operating system or BIOS of a processing system (e.g., processing system 100) may read from certain of the MSRs 112 to carry out a microcode update. While the MSRs 112 may include numerous different registers, a subset of registers relating to microcode updates are shown in FIG. 10. A Capability Register Availability field of the output of a CPUID instruction (e.g., CPUID.(EAX=7H,ECX=0):EDX[29]) may indicate whether the MSRs 112 include an Architecture Capability Register 974 (e.g., IA32_ARCH_CAPABILITIES or ARCH_CAPABILITIES). The Architecture Capability Register 974 may similarly include a variety of fields that indicate whether the processing system supports certain modes, is susceptible to certain conditions, or is overclocked. One of the fields of the Architecture Capability Register 974 is a Microcode Enumeration Availability field 976 (e.g., MCU_ENUM_AVAIL, bit 16 of the Architecture Capability Register 974) that indicates whether the MSRs 112 include a Microcode Enumeration register 978 (e.g., IA32_MCU_ENUMERATION or MCU_ENUMERATION, MSR 7BH) and/or a Microcode Status register 980 (e.g., IA32_MCU_STATUS or MCU_STATUS, MSR 7CH). The Update Trigger register 116 (e.g., IA32_BIOS_UPDT_TRIG or BIOS_UPDT_TRIG) may be used to perform a microcode update by executing a write MSR instruction (e.g., WRMSR) to the Update Trigger register 116.

Any suitable microcode update loader may be used. One assembly code example of a microcode update loader is shown as follows:

| mov | ecx, 79h | ; MSR to write in ECX |
|---|---|---|
| xor | eax, eax | ; clear EAX |
| xor | ebx, ebx | ; clear EBX |
| mov | ax, cs | ; Segment of microcode update |
| shl | eax, 4 | |
| mov | bx, offset Update | ; Offset of microcode update |
| add | eax, ebx | ; Linear Address of Update in EAX |
| add | eax, 48d | ; Offset of the Update Data within the Update |
| xor | edx, edx | ; Zero in EDX |

| | |
|---|---|
| WRMSR | ; microcode update trigger |

In the example above, Update is the address of a microcode update (header and data) embedded within a code segment of the BIOS. For example, the data may reside anywhere in memory assigned on a 16-byte boundary that is accessible by the processor within its current operating mode. It should be appreciated that other microcode update loaders may be used by the operating system or the BIOS.

The Microcode Enumeration register 978 may represent one example of the MCU scope register 114 discussed above with reference to FIG. 1. The Microcode Enumeration register 978 may include several fields, such as a Uniform Microcode Update Availability field 982 (e.g., UNIFORM_MCU_AVAIL), a Uniform Microcode Update-Configuration Required field 984 (e.g., UNIFORM_MCU_CONFIG_REQD), a Uniform Microcode Update-Configuration Complete field 986 (e.g., UNIFORM_MCU_CONFIG_COMPLETE), and a Uniform Microcode Update Scope field 988 (e.g., UNIFORM_MCU_SCOPE). These fields of the Microcode Enumeration register 978 may take up any suitable number of bits to provide information about the microcode update capabilities of the processing system. In one example, the bit fields of the Microcode Enumeration register 978 may be as follows in Table 1:

TABLE 1

| Bit Field | Name |
|---|---|
| 0 | UNIFORM_MCU_AVAIL |
| 1 | UNIFORM_MCU_CONFIG_REQD |
| 2 | UNIFORM_MCU_CONFIG_COMPLETE |
| 7:3 | Reserved |
| 10:8 | UNIFORM_MCU_SCOPE |
| 63:11 | Reserved |

The Uniform Microcode Update Availability field 982 may include a bit that indicates one of two possible states. In one example, when the Uniform Microcode Update Availability field 982 is set to a first state (e.g., 1), this may indicate that the processing system has the capability to perform uniform microcode update is available, and that the Uniform Microcode Update Scope field 988 may be used to ascertain the microcode update scope. When the Uniform Microcode Update Availability field 982 is set to a second state (e.g., 0), this indicates that the processing system 100 lacks the capability to perform uniform microcode updates and, accordingly, microcode updates may be performed on a per-core scope.

The Uniform Microcode Update-Configuration Required field 984 relates to certain processing systems that may first perform a configuration before a microcode update may be attempted. For certain versions of the processing system 100, for example, processor reserved memory range registers (PRMRR) may be configured by configuration firmware such BIOS to reserve one or more physically contiguous ranges of memory before a microcode update may be attempted. Thus, the Uniform Microcode Update-Configuration Required field 984 may include a bit that indicates one of two possible states that indicates whether or not the processing system 100 is one that first performs a configuration before a microcode update may be attempted. If set to one state (e.g., 1), this indicates that the processing system 100 is one that performs configuration and microcode updates may not begin until configuration is confirmed. If set to the other state (e.g., 0), this indicates that the processing system 100 is not one that performs configuration and microcode updates may proceed without confirmation of configuration. The Uniform Microcode Update-Configuration Complete field 986 may include one bit that indicates whether the configuration has been completed. If set to one state (e.g., 1), this indicates that the processing system 100 has been configured and is ready to undergo a microcode update. If set to the other state (e.g., 0), this indicates that the processing system 100 has not been configured and is not ready to undergo the microcode update.

Before continuing, it may be noted that the BIOS may cause the Uniform Microcode Update-Configuration Complete field 986 to be set when configuration has been completed. For example, on boot, the BIOS may check the Microcode Enumeration Availability field 976 of the Architecture Capability Register 974. When set, it is an indication to the BIOS that the CPU supports uniform microcode update mechanism, and new microcode update specific MSRs 978 and 980 are available. If the Uniform Microcode Update Availability field 982 and the Uniform Microcode Update-Configuration Required field 984 are 1, the BIOS is specified to correctly configure PRMRR MSRs before a microcode update is permitted to take place. In one particular example, the BIOS may program PRMRR MSRs (e.g., PRMRR_BASE_0, MSR 0x1A0 and PRMRR_MASK, MSR 0x1F5) with 16 MB without regard for sizes in MSR 0x1FB. Once configuration is complete, the BIOS may set the Uniform Microcode Update-Configuration Complete field 986 to indicate that the processor is configured for a microcode update.

The Uniform Microcode Update Scope field 988 may include several bits that indicate the uniform microcode update scope. For example, the bits may represent states that indicate whether the processing system 100 is core scoped (e.g., 0), package scoped (e.g., 1), or platform scoped (e.g., 2). There may also be many bits that are reserved for other scopes that may be used in the future.

The Microcode Status register 980 may include a Microcode Update Partial Update field 990 (e.g., MCU_PARTIAL_UPDATE) and an Authorization Failure on Microcode Update Component field 992 (e.g., AUTH_FAIL_ON_MCU_COMPONENT). In one example, the bit fields of the Microcode Status register 980 may be as follows in Table 2:

TABLE 2

| Bit Field | Name |
|---|---|
| 0 | UNIFORM_MCU_AVAIL |
| 1 | UNIFORM_MCU_CONFIG_REQD |
| 63:2 | Reserved |

The Microcode Update Partial Update field 990 may include a bit that indicates whether the most recent attempt to update the microcode (e.g., via a write to the Update Trigger register 116) resulted in a partial update. When set to a first state (e.g., 1), this means that microcode update components were only partially updated after some portion of the microcode update had already been committed and the Revision ID of the microcode had been updated. When set to a second state (e.g., 0), this is not the case. The Authorization Failure on Microcode Update Component field 992 may include a bit that indicates whether an authentication failure occurred on some portion of the microcode update after another portion of the microcode update had already been committed and the Revision ID of the microcode had been updated on the most recent attempt to update the microcode (e.g., via a write to the Update Trigger register 116).

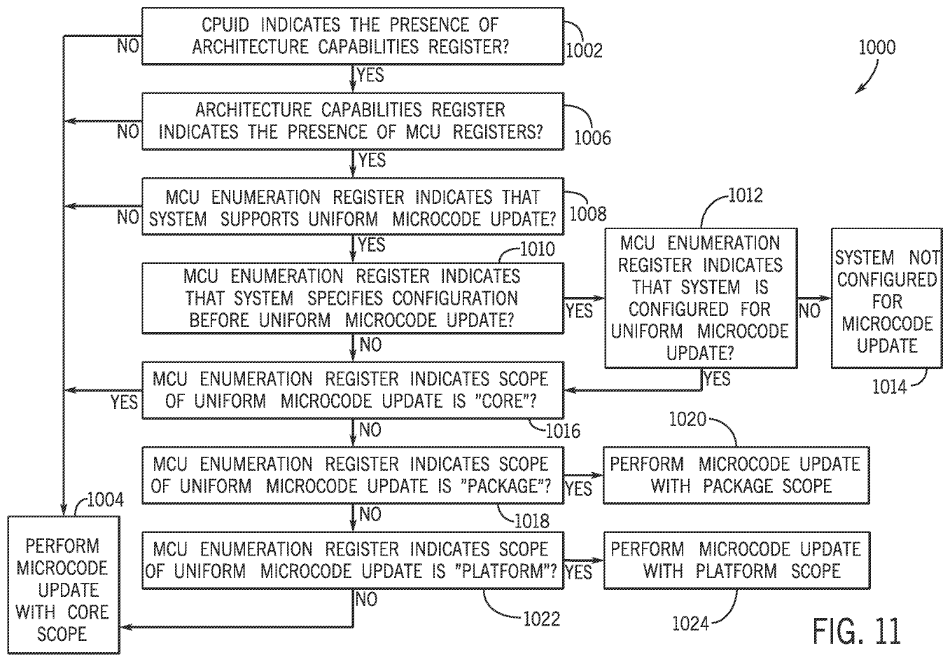

Low-level software such as an operating system or BIOS of a processing system (e.g., processing system 100) may use the MSRs 112 to perform a microcode update. For example, as shown by a flowchart 1000 of FIG. 11, the software (e.g., the operating system or BIOS) may read a Capability Register Availability field of the output of a CPUID instruction (e.g., CPUID.(EAX=7H,ECX=0):EDX[29]). If the Capability Register Availability field indicates that there is not an Architecture Capability Register 974 (e.g., IA32_ARCH_CAPABILITIES OR ARCH_CAPABILITIES) (block 1002), the software may perform the microcode update on a per-core basis (block 1004). If the Capability Register Availability field indicates that there is an Architecture Capability Register 974 at block 1002, the software may read the Microcode Enumeration Availability field 976 (e.g., MCU_ENUM_AVAIL) of the Architecture Capability Register 974. If the Microcode Enumeration Availability field 976 indicates that the Microcode Enumeration register 978 is not present (block 1006), the software may perform the microcode update on a per-core basis (block 1004). If the Microcode Enumeration Availability field 976 indicates that this register is present (block 1006), the software may read the Microcode Enumeration register 978.

For example, at block 1008, if the Uniform Microcode Update Availability field 982 (e.g., UNIFORM_MCU_AVAIL) of the Microcode Enumeration register 978 indicates that the processing system does not support uniform microcode updates, the software may perform the microcode update on a per-core basis (block 1004). Otherwise, the software may read the Uniform Microcode Update-Configuration Required field 984 (e.g., UNIFORM_MCU_CONFIG_REQD) of the Microcode Enumeration register 978. If the Uniform Microcode Update-Configuration Required field 984 indicates that the processing system is specified to be configured before a microcode update may take place (block 1010), the software may read the Uniform Microcode Update-Configuration Complete field 986 (e.g., UNIFORM_MCU_CONFIG_COMPLETE) of the Microcode Enumeration register 978. If the Uniform Microcode Update-Configuration Complete field 986 indicates that the configuration is not complete (block 1012), the software may determine not to perform a microcode update as the system is not yet configured (block 1014). If, at block 1010, the Uniform Microcode Update—Configuration Required field 984 indicates that the processing system is not specified to be configured or, at block 1012, the Uniform Microcode Update-Configuration Complete field 986 indicates that configuration is complete, the process may flow to block 1016.

At block 1016, the software may read the Uniform Microcode Update Scope field 988 (e.g., UNIFORM_MCU_SCOPE) of the Microcode Enumeration register 978. If the Uniform Microcode Update Scope field 988 indicates a per-core scope (block 1016), the software may perform the microcode update on a per-core basis (block 1004). Otherwise, if the Uniform Microcode Update Scope field 988 indicates a per-package scope (block 1018), the software may perform the microcode update on a per-package basis (block 1020). Otherwise, if the Uniform Microcode Update Scope field 988 indicates a per-platform scope (block 1022), the software may perform the microcode update on a per-platform basis (block 1024).

In addition, performing the microcode update may further involve reading the Microcode Status register 980. For example, the processor core(s) may update the Microcode Update Partial Update field 990 and the Authorization Failure on Microcode Update Component field 992 based on the results of the microcode update. The software may read the Microcode Update Partial Update field 990 and the Authorization Failure on Microcode Update Component field 992 to verify that the microcode update has been completed successfully.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

### Example Embodiments

EXAMPLE EMBODIMENT 1. A processing device comprising:
a first processor core comprising a register to indicate a hardware capability of the processing device to propagate a microcode update from the first processor core to a second processor core; and
the second processor core.

EXAMPLE EMBODIMENT 2. The processing device of example embodiment 1, wherein the register comprises a field to indicate a type of the uniform microcode update.

EXAMPLE EMBODIMENT 3. The processing device of example embodiment 2, wherein the type of the microcode update comprises at least one of a package scope or a platform scope.

EXAMPLE EMBODIMENT 4. The processing device of example embodiment 1, wherein the register comprises a field to indicate that configuration by a basic input/output system (BIOS) is specified to enable the microcode update to take place.

EXAMPLE EMBODIMENT 5. The processing device of example embodiment 1, wherein the register comprises a field to indicate that configuration by a basic input/output system (BIOS) has been completed.

EXAMPLE EMBODIMENT 6. The processing device of example embodiment 1, wherein the register is accessible to a basic input/output system (BIOS) or an operating system but not an user-application program.

EXAMPLE EMBODIMENT 7. The processing device of example embodiment 1, comprising an additional register to indicate a status of the microcode update.

EXAMPLE EMBODIMENT 8. The processing device of example embodiment 7, wherein the additional register comprises a field to indicate whether a most recent attempt to update the microcode resulted in a partial update.

EXAMPLE EMBODIMENT 9. The processing device of example embodiment 7, wherein the additional register comprises a field to indicate whether an authentication failure occurred on some portion of the microcode update after different portion of the microcode update had been committed.

EXAMPLE EMBODIMENT 10. The processing device of example embodiment 1, wherein the first processor core comprises another register to indicate a presence of the register to indicate the hardware capability to perform the microcode update.

EXAMPLE EMBODIMENT 11. The system of example embodiment 1, wherein the first processor core and the second processor core are disposed in a first package and communicatively coupled on a same platform to a third processor core and a fourth processor core of a second package, wherein the register is to indicate that the hardware capability is to perform the uniform microcode update by propagating the microcode update from the first package to the second package.

EXAMPLE EMBODIMENT 12. One or more tangible, non-transitory, machine-readable media comprising instructions that, when executed by one or more processors, cause the one or more processors to perform operations comprising:
reading a first field of a first register of a processing system to determine that the processing system supports a uniform microcode update of a defined scope; and
initiating the uniform microcode update to take place according to the defined scope based on the first field of the first register.

EXAMPLE EMBODIMENT 13. The one or more machine-readable media of example embodiment 12, wherein the instructions, when executed, cause the one or more processors to perform operations comprising:
executing a CPUID instruction;
reading a first field of an output of the CPUID instruction to determine whether a second register is present in the processing system;
in response to determining that the second register is present, reading a first field of the second register to determine whether the first register is present in the processing system;
and

in response to determining that the first register is present, reading the first field of the first register.

EXAMPLE EMBODIMENT 14. The one or more machine-readable media of example embodiment 13, wherein the second register comprises a capabilities register.

EXAMPLE EMBODIMENT 15. The one or more machine-readable media of example embodiment 12, wherein the instructions, when executed, cause the one or more processors to perform operations comprising:
reading a second field of the first register to determine whether the processing system is specified to be configured before a microcode update is to occur; and
in response to determining that the processing system is specified to be configured before the microcode update is to occur, reading a third field of the first register to determine whether the processing system is configured.

EXAMPLE EMBODIMENT 16. The one or more machine-readable media of example embodiment 12, wherein the instructions, when executed, cause the one or more processors to perform operations comprising:

in response to determining that the processing system supports the uniform microcode update of the defined scope, reading a second field of the first register to determine the defined scope.

EXAMPLE EMBODIMENT 17. The one or more machine-readable media of example embodiment 12, wherein the instructions comprise a basic input/output system (BIOS) or an operating system (OS) of the processing system.

EXAMPLE EMBODIMENT 18. The one or more machine-readable media of example embodiment 12, wherein the instructions, when executed, cause the one or more processors to perform operations comprising initiating the uniform microcode update by executing a write model specific register instruction (WRMSR) to a defined register that causes a microcode update in one of the one or more processors.

EXAMPLE EMBODIMENT 19. The one or more machine-readable media of example embodiment 18, wherein the instructions, when executed, cause the one or more processors to perform operations comprising reading a first field of a second register of the processing system to determine whether the uniform microcode update completed successfully.

EXAMPLE EMBODIMENT 20. A processor that includes model-specific registers comprising:
a first register comprising:
a first field to indicate a scope of a microcode update hardware capability of the processor.

EXAMPLE EMBODIMENT 21. The processor of example embodiment 20, wherein the first register comprises:
a second field to indicate a specification that the processor be configured to be able to perform the microcode update; and
a third field to indicate whether the processor is configured to perform the microcode update.

EXAMPLE EMBODIMENT 22. The processor of example embodiment 21, wherein the model specific registers comprise:
a second register comprising:
   a first field to indicate whether the microcode update has resulted in a partial update; and
   a second field to indicate whether an authentication error has occurred during the microcode update.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A processing device comprising:
a first processor core comprising a register to indicate a hardware capability of the processing device to propagate a microcode update from the first processor core to a second processor core; and
the second processor core.

2. The processing device of claim 1, wherein the register comprises a field to indicate a type of the uniform microcode update.

3. The processing device of claim 2, wherein the type of the microcode update comprises at least one of a package scope or a platform scope.

4. The processing device of claim 1, wherein the register comprises a field to indicate that configuration by a basic input/output system (BIOS) is specified to enable the microcode update to take place.

5. The processing device of claim 1, wherein the register comprises a field to indicate that configuration by a basic input/output system (BIOS) has been completed.

6. The processing device of claim 1, wherein the register is accessible to a basic input/output system (BIOS) or an operating system but not an user-application program.

7. The processing device of claim 1, comprising an additional register to indicate a status of the microcode update.

8. The processing device of claim 7, wherein the additional register comprises a field to indicate whether a most recent attempt to update the microcode resulted in a partial update.

9. The processing device of claim 7, wherein the additional register comprises a field to indicate whether an authentication failure occurred on some portion of the microcode update after different portion of the microcode update had been committed.

10. The processing device of claim 1, wherein the first processor core comprises another register to indicate a presence of the register to indicate the hardware capability to perform the microcode update.

11. The system of claim 1, wherein the first processor core and the second processor core are disposed in a first package and communicatively coupled on a same platform to a third processor core and a fourth processor core of a second package, wherein the register is to indicate that the hardware capability is to perform the uniform microcode update by propagating the microcode update from the first package to the second package.

12. One or more tangible, non-transitory, machine-readable media comprising instructions that, when executed by one or more processors, cause the one or more processors to perform operations comprising:
reading a first field of a first register of a processing system to determine that the processing system supports a uniform microcode update of a defined scope; and
initiating the uniform microcode update to take place according to the defined scope based on the first field of the first register.

13. The one or more machine-readable media of claim 12, wherein the instructions, when executed, cause the one or more processors to perform operations comprising:
executing a CPUID instruction;
reading a first field of an output of the CPUID instruction to determine whether a second register is present in the processing system;
in response to determining that the second register is present, reading a first field of the second register to determine whether the first register is present in the processing system; and
in response to determining that the first register is present, reading the first field of the first register.

14. The one or more machine-readable media of claim 13, wherein the second register comprises a capabilities register.

15. The one or more machine-readable media of claim 12, wherein the instructions, when executed, cause the one or more processors to perform operations comprising:
reading a second field of the first register to determine whether the processing system is specified to be configured before a microcode update is to occur; and
in response to determining that the processing system is specified to be configured before the microcode update is to occur, reading a third field of the first register to determine whether the processing system is configured.

16. The one or more machine-readable media of claim 12, wherein the instructions, when executed, cause the one or more processors to perform operations comprising:
in response to determining that the processing system supports the uniform microcode update of the defined scope, reading a second field of the first register to determine the defined scope.

17. The one or more machine-readable media of claim 12, wherein the instructions comprise a basic input/output system (BIOS) or an operating system (OS) of the processing system.

18. The one or more machine-readable media of claim 12, wherein the instructions, when executed, cause the one or more processors to perform operations comprising initiating the uniform microcode update by executing a write model specific register instruction (WRMSR) to a defined register that causes a microcode update in one of the one or more processors.

19. The one or more machine-readable media of claim 18, wherein the instructions, when executed, cause the one or more processors to perform operations comprising reading a first field of a second register of the processing system to determine whether the uniform microcode update completed successfully.

20. A processor that includes model-specific registers comprising:
a first register comprising:
a first field to indicate a scope of a microcode update hardware capability of the processor.

21. The processor of claim 20, wherein the first register comprises:
a second field to indicate a specification that the processor be configured to be able to perform the microcode update; and
a third field to indicate whether the processor is configured to perform the microcode update.

22. The processor of claim 21, wherein the model specific registers comprise:
a second register comprising:
a first field to indicate whether the microcode update has resulted in a partial update; and
a second field to indicate whether an authentication error has occurred during the microcode update.
